(19) United States
(12) Patent Application Publication
(10) Pub. No.: US 2025/0005979 A1
(43) Pub. Date: Jan. 2, 2025

(54) METHOD FOR ACTIVATING A VEHICLE FUNCTION AND ASSOCIATED DEVICE

(71) Applicant: Continental Automotive Technologies GmbH, Hannover (DE)

(72) Inventors: Rachid BENBOUHOUT, AUTERIVE (FR); Burak SAHINBAS, REGENSBURG (DE); Maximilian TREINDL, Wenzenbach (DE)

(73) Assignee: Continental Automotive Technologies GmbH, Hannover (DE)

(21) Appl. No.: 18/749,916

(22) Filed: Jun. 21, 2024

(30) Foreign Application Priority Data
Jun. 29, 2023 (FR) 2306903

(51) Int. Cl. G07C 9/00; B60R 25/20; B60R 25/22; G01S 13/02; H04W 4/40

(52) U.S. Cl. CPC G07C 9/00309; B60R 25/2018; B60R 25/22; G01S 13/0209; H04W 4/40; G07C 2209/65

(57) ABSTRACT

A method for activating a vehicle function, by an activation device, from a user's “hands-free” access equipment. Activation of the function triggered by detection of a press of the user on a contact surface of the vehicle. The device includes at least one transceiver located under the contact surface able to communicate with the piece of equipment via ultra-wideband. The method includes: transmission of waves to the piece of equipment; reception of reflected waves; comparison, during a predetermined length of time of: i) values of the phase of the reflected waves with a predetermined phase-value profile exhibiting a phase rotation, and ii) values of the amplitude of the reflected waves with a predetermined amplitude-value profile exhibiting an increase in amplitude; detection of a press of the user on the contact surface depending on the result of the comparisons; activation of the vehicle function if the press has been detected.

### CROSS REFERENCE TO RELATED APPLICATIONS

This application claims priority to French Patent Application No. 2306903, filed Jun. 29, 2023, the contents of such application being incorporated by reference herein.

### FIELD OF THE INVENTION

The present invention relates to the field of motor vehicles and more specifically relates to a method for activating a function of a motor vehicle, and to an associated device. The invention particularly applies to the function of locking and unlocking the doors of a motor vehicle.

### BACKGROUND OF THE INVENTION

In a motor vehicle, it is known to use presence-detection devices to detect the presence of a hand or a foot of a user of the vehicle and thus allow all or some of the hatches of the vehicle to be locked or unlocked (hatches here meaning the passenger-compartment doors, the lid of the trunk, the lid of the frunk where appropriate and potentially even the hood). By way of example, detecting the presence of a hand of a user on or in front of a door handle, combined with the recognition of an identifier of a “hands-free” access device carried by this user, allows these hatches to be locked and unlocked.

For this purpose, when the user approaches the vehicle, communication is established, over a wireless communication link, between the access device, for example an electronic keycard or a cell phone, and the detection device, in order to authenticate said access device using its identifier.

To this end, the detection device comprises an antenna allowing the identifier sent by the access device to be received. The detection device is connected to an electronic control unit (ECU) of the vehicle, to which it transmits the identifier.

In the prior art, the access device is generally an electronic keycard. The signal received by the antenna of the detection device, containing the identifier of the access device, is sent via radio-frequency (RF) or low-frequency (LF) waves.

However, nowadays it is increasingly common to use a cell phone to perform authentication functions, this making it possible to avoid use of a dedicated electronic keycard and thus to limit the number of pieces of equipment required. Since most cell phones do not possess RF or LF communication means, it is known practice to use, for example, UWB communication (UWB standing for Ultra-WideBand) with which most existing telephones are equipped, to send the identifier of the device in the case of a function for unlocking a vehicle.

Approach of the access device to within proximity of the detection device (less than 10 cm away) and recognition of the identifier received by the computer, combined with detection of the presence of the user's hand, allows the door to be locked or unlocked.

In order to detect the presence of the user's hand and allow the hatches of the vehicle to be unlocked, such a detection device conventionally comprises, in a known manner, a capacitive sensor. Usually, a capacitive sensor is dedicated to one detection area, and, in the prior art, there is one capacitive sensor for the unlocking area and one capacitive sensor for the locking area, the two areas being separate.

According to one example of capacitive measurement, such a capacitive sensor comprises a first capacitor that is charged and discharged periodically from/into a second capacitor. When the first capacitor is discharged into the second capacitor, the charges on the two capacitors eventually reach balance.

When a hand is present on the handle or in proximity to the handle, less than 10 mm away for example, the charge level of the first capacitor rises. This causes a greater discharge from the first capacitor into the second capacitor, and therefore a higher balance level in the presence of a hand on the handle than in its absence. Thus such a sensor may be used to detect a user's intention to unlock the hatches of the vehicle.

However, use of capacitive sensors has many drawbacks:

Detection of the approach of a user by capacitive sensors is not robust and generates false detections.

In particular, under certain environmental conditions, when the ambient air is wet, or when salt is present on the roads and is sprayed onto the metal bodywork of the vehicle, capacitive coupling is created between the detection areas and the metal parts of the vehicle, preventing any detection of a user's presence by the capacitive sensors.

Moreover, raindrops or snowflakes on the door handle increase the value of the capacitance measured by the capacitive sensors, thus giving rise to false positives.

Lastly, detection by capacitive sensors is incompatible with handles coated with metallic paints or comprising chromed surfaces, the presence of metal in the handle creating coupling with the detection areas and inhibiting detection of the presence of a user.

While false detections are undesirable in some vehicles, they are not tolerated in other vehicles.

This is the case with vehicles equipped with deployable handles, i.e. the case with handles where detection of the user's presence is used to command movement of a motorized handle which, when at rest, is completely incorporated into the door and, when activated, is deployed and projects out of the door. With this type of handle, untimely deployment or retraction of the handle due to false detection by the capacitive sensors runs the risk of the user's hand being struck or pinched.

This is also the case with vehicles equipped with an automatic opening system, whereby detection of unlocking results not only in the door being unlocked but also in it being opened. In this case, false detections result in untimely opening of the door.

Lastly, false detections are not tolerable in vehicles equipped with a “Safe Lock” security function, whereby detection of locking causes not only the vehicle to be locked from the outside but also the vehicle to be locked from the inside (anti-theft device). In this case, false detections may lead to the user being shut inside the vehicle.

To overcome these drawbacks, it is known practice in the prior art to replace at least one of the capacitive sensors, for example the capacitive sensor dedicated to locking the vehicle, with a press-detection sensor, for example an inductive sensor comprising a metal target that moves toward a coil of the sensor when the user presses on the locking or unlocking zone. The variation in the inductance of the coil of the inductive sensor, due to the target approaching the coil, allows validation of detection of the user's intention to lock or unlock the vehicle.

However, integration of a UWB communication device and of an inductive press-detection sensor into the same vehicle door handle has a major drawback, as space in handles is becoming increasingly restricted (for reasons related to handle aesthetics) mechanical integration of components is no longer always possible due to a lack of space and is costly.

An aspect of the invention provides a method for activating a function of a vehicle and a device, in this instance for unlocking and/or locking a vehicle door, allowing the drawbacks of the prior art to be overcome. More particularly, the invention provides an UWB communication device that has been improved and modified to also allow a user's press on a dedicated surface to be detected, saving space and decreasing cost with respect to the prior art.

### SUMMARY OF THE INVENTION

An aspect of the invention relates to a method for activating a vehicle function, by means of an activation device, from a piece of “hands-free” access equipment borne by a user, activation of the function being triggered by detection of a press of the user on a contact surface of the vehicle, and depending on a result of authentication of the piece of equipment, the activation device comprising at least one transceiver that is located under the contact surface and that is able to communicate with said piece of equipment via ultra-wideband, the method being noteworthy in that it comprises the following steps:
a. ultra-wideband transmission to said piece of equipment,
b. reception of reflected waves,
c. comparison, during a predetermined length of time,
   i.of values of the phase of the reflected waves with a predetermined phase-value profile, said profile exhibiting a phase rotation, and
   ii.of values of the amplitude of the reflected waves with a predetermined amplitude-value profile, said profile exhibiting an increase in amplitude,
d. detection of a press of the user on the contact surface depending on the result of said comparisons,
e. activation of the vehicle function if the press has been detected.

Preferably, a phase rotation corresponds to a variation of the phase values comprised between −180° and −270° during the predetermined length of time.

Furthermore, an increase in amplitude preferably corresponds to a variation in amplitude values above a threshold during the predetermined length of time.

An aspect of the invention relates to any device for activating a vehicle function, said device being configured to be installed in a motor vehicle, activation of the function being triggered by detection of a press of the user on a contact surface of the vehicle, and depending on a result of authentication of the piece of equipment, the activation device comprising at least one transceiver that is located under the contact surface and that is able to communicate with said piece of equipment via ultra-wideband, the device being noteworthy in that it comprises:
a. means for receiving reflected ultra-wideband waves,
b. means for comparing, during a predetermined length of time, values of the phase of the reflected waves with a predetermined phase profile, said profile exhibiting a phase rotation,
c. means for comparing, during the predetermined length of time, values of the amplitude of the reflected waves with a predetermined amplitude-value profile, said profile exhibiting an increase in amplitude,
d. means for detecting a press of the user on the contact surface depending on the results of said comparison,
e. means for activating the vehicle function if the press has been detected.

Preferably, the means for comparing values of the phase of the reflected waves compare said values with a phase rotation comprised between −180° and −270° during the predetermined length of time.

Furthermore, the means for comparing values of the amplitude preferably compare said values with an increase in amplitude above a threshold during the predetermined length of time.

An aspect of the invention also relates to any computer program product comprising program code instructions for executing the steps of the method according to any one of the features listed above when said program is executed on a computer.

Lastly, an aspect of the invention relates to any motor vehicle comprising an activation device according to the features listed above.

### BRIEF DESCRIPTION OF THE DRAWINGS

Other features and advantages of aspects of the invention will become more clearly apparent on reading the following description. This is purely illustrative and should be read with reference to the appended drawings, in which:

FIG. 1 schematically shows a vehicle equipped with an activation device according to an aspect of the invention,

FIG. 2 shows a door handle comprising an ultra-wideband antenna according to an aspect of the invention,

FIG. 3 shows the activation device according to an aspect of the invention,

FIG. 4 contains two graphs, a first graph located at the top of FIG. 4 illustrating the amplitude as a function of time during transmission of an ultra-wideband wave and a second graph located at the bottom of FIG. 4 illustrating the channel impulse response as a function of time during reception of the ultra-wideband wave reflected,

FIG. 5 schematically shows a user's finger approaching, touching and then pressing on the contact surface, and a chart of the phase and quadrature phase of the reflected waves for each of these three cases,

FIG. 6 is a graph showing the variation in the phase and quadrature phase of the reflected waves during the predetermined length of time, and the variation in phase and amplitude corresponding to a press of the user's finger on the contact surface,

FIG. 7 is a flowchart illustrating the steps of the activation method according to an aspect of the invention.

### DETAILED DESCRIPTION OF EXEMPLARY EMBODIMENTS

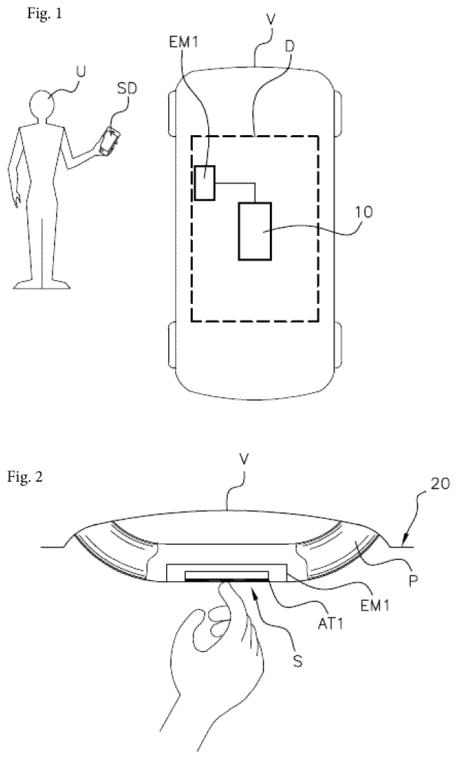

FIG. 1 shows a motor vehicle V equipped with a device D for activating a vehicle function according to an aspect of the invention. The activation device D comprises at least one UWB transceiver EM1 (UWB standing for Ultra-WideBand) that is able to communicate via ultra-wideband with a portable piece of access equipment SD, for example a smartphone or an electronic key borne by a user U.

The activation device D further comprises a central control unit 10 electronically connected to the transceiver EM1.

This central control unit 10 makes it possible to manage transmission and reception of UWB data by the transceiver. This is known in the art and will not be described in more detail here.

What is meant by ultra-wideband (UWB) communication is radiofrequency communication which is based on transmitting pulses of a very short duration, often less than one nanosecond. Thus, bandwidth may reach very high values between 250 and 500 MHz and beyond. It will be noted that an aspect of the invention also applies to any other communication means allowing a broadband signal to be obtained, for example Wi-Fi, which uses an OFDM modulation (OFDM standing for Orthogonal Frequency Division Multiplexing), i.e. a method for coding digital signals through distribution between orthogonal frequencies taking the form of multiple sub-carriers.

According to an aspect of the invention, the transceiver EM1 is located in an element of the bodywork accessible to the user through touch. Preferably, the transceiver EM1 is located in a door handle, whether or not it is deployable, in the pillar of the driver's door, in a rear-view mirror, etc., or in other words in an element of the bodywork that the user can easily touch. The transceiver EM1 may also be comprised in an insert located in a window of the driver's door. This location is advantageous insofar as the transceiver EM1 is thus able to transmit either toward inside the vehicle, or toward outside the vehicle, the window attenuating the waves only very slightly when they pass through it.

In the example illustrated in FIG. 2, the transceiver EM1 is located in a handle P of a door 20 of a motor vehicle V. The transceiver EM1 comprises, in a manner known per se, a UWB antenna AT1, which is located under a contact surface S. The contact surface S is oriented, preferably but non-limitingly, toward outside the vehicle V. Activation of the vehicle function is triggered by a press of the user U on this contact surface S, as will be explained below. The contact surface S may be elastically deformable; however, an aspect of the invention also operates with a rigid contact surface, for example one made of rigid plastic.

According to an aspect of the invention, activation of a vehicle function, here unlocking of hatches, is based on prior authentication of the piece of access equipment via ultra-wideband or Bluetooth (this method being known to those skilled in the art, it will not be described in more detail here) and, according to an aspect of the invention, the press of part of the user's body on a contact surface under which the ultra-wide band antenna is located, as will be described in detail below.

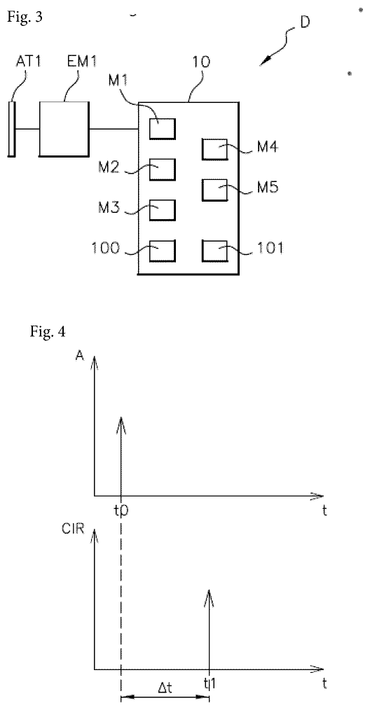

According to an aspect of the invention, the activation device D further comprises (cf. FIG. 3):
a. means M1 for receiving reflected ultra-wideband waves,
b. means M2 for comparing, during a predetermined length of time ΔT, values of the phase φ of the reflected waves with a predetermined phase profile, said profile exhibiting a phase rotation comprised in a range of angular values,
c. means M3 for comparing, during the predetermined length of time ΔT, values of the amplitude A of the reflected waves with a predetermined amplitude-value profile, said profile exhibiting an increase in amplitude above a predetermined threshold,
d. means M4 for detecting a press of a part of the user's body (a finger for example) on the contact surface S depending on the results of said comparisons,
e. means M5 for activating the vehicle function if the press has been detected.

The reception means M1, the means M2 for comparing phase values, the means M3 for comparing amplitude values, the detection means M4 and the activation means M5 preferably take the form of software comprised in an integrated circuit of the central control unit 10 (cf. FIG. 3).

The central control unit 10 also comprises a processor 100 and a memory 101 (cf. FIG. 3) in which are stored instructions allowing the processor to be configured to execute certain particular processing operations, and in particular to implement the steps of the activation method, according to the embodiment as is described below.

The means M1 for receiving reflected ultra-wideband waves comprise software-processing means allowing an analysis of the channel impulse response (CIR) of the reflected waves.

This is illustrated in FIG. 4. At the top of FIG. 4 the amplitude A as a function of time t of a UWB wave emitted at the time t=t0 by the activation device D and oriented toward outside the vehicle V has been shown.

At the bottom of FIG. 4 the channel impulse response (CIR) of a wave reflected by the whole body or part of the body of the user U bearing the piece of access equipment SD, and received by the activation device D at the time t=t1, has been shown.

It is known to estimate the distance separating the user U bearing the piece of access equipment SD and the activation device D (or the vehicle V) using the time difference Δt between the time t0 of transmission of the wave and the time t1 of reception of the reflected wave, and the speed of the light. This is known in the prior art.

The received reflected-wave signal is a complex signal having an amplitude A and a phase φ.

It is important to note that the reflected waves are received simultaneously with transmission of the waves. There is no stoppage between transmission of the waves and their reception: transmission and reception occur in parallel, with a very slight offset corresponding to the round-trip path of the waves and to the distance of the piece of access equipment SD.

According to an aspect of the invention, the phase φ and the amplitude A of the received reflected-wave signals are thus stored for a predetermined length of time ΔT, for example of a minimum duration equal to 4 seconds, namely the time allotted for the wave to make a round trip, for example when the user touches the contact surface S.

The comparison means M2 then compare, over the predetermined length of time ΔT, the values of the phase φ with a predetermined phase-value profile.

The comparison is based on acquisition over time of samples of the digitized reflected signal taking the form of a composite I/Q signal (I standing for in-phase and Q standing for quadrature phase). The shape of the reflected signal will depend, inter alia, on the shape and distance of the object reflecting the waves (here the body of the user) and on its radar cross section (RCS). This method is known to those skilled in the art.

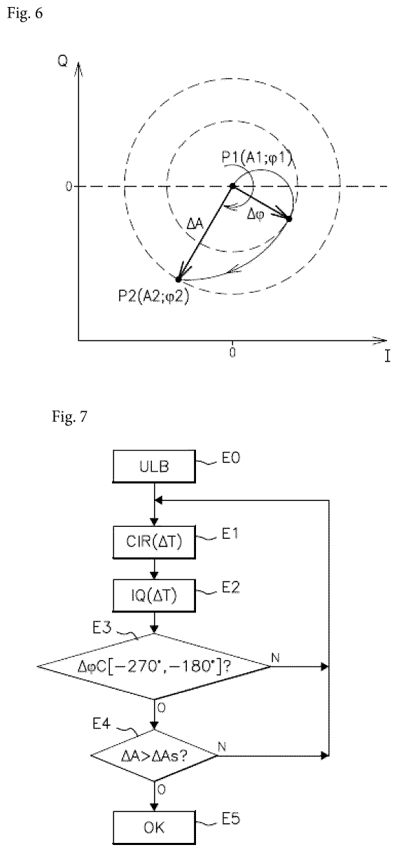

This is illustrated in FIG. 6, which shows the Q and I values of the reflected-wave signals received during the predetermined length of time ΔT when the user approaches then effects a valid press on the contact surface S. The first received reflected-wave signal P1 has a phase φ1 and an amplitude A1. At the end of the predetermined length of time, the last received reflected-wave signal P2 has a phase φ2 and an amplitude A2.

During this approach then press, the phase varies from φ1=+45° to φ2=−135° and therefore undergoes a rotation, clockwise of a value of Δφ=−180°.

The predetermined phase-value profile therefore exhibits a rotation comprised between −180° and −270° that may be adjusted depending on the mechanics and performance of the transceiver EM1. This will be explained below.

The means M3 for comparing the values of the amplitude A compare the values of the amplitude A of the received reflected-wave signals with a predetermined amplitude profile.

In FIG. 6, the variation in amplitude from the value A1 of the first signal to the value A2 of the last signal is positive. In other words, an approach then a valid press by the user on the contact surface S results in an increase ΔA=A2−A1 in the amplitude values over the predetermined length of time ΔT.

The predetermined amplitude-value profile corresponding to an approach followed by a press consists of an increase in the value of the amplitude by a minimum of ΔAs equal for example to at least 50% of the initial amplitude value A1. Of course, this increase threshold ΔAs will have been calibrated beforehand. Here, in this example, it is equal to 1.5*A1. This example is completely non-limiting. This threshold may also be calibrated based on a maximum amplitude measured when the user touches the contact surface, the threshold then representing a minimum percentage of this maximum amplitude.

The means M4 for detecting a press make it possible to validate a press of the user on the contact surface S, if, during the predetermined length of time ΔT:
a. the means M2 for comparing phase values determined a rotation of the phase comprised within the aforementioned values, and
b. the means M3 for comparing the values of the amplitude A determined an increase in amplitude beyond the aforementioned threshold ΔAs, i.e. of at least 50% for example.

The means M5 for activating a vehicle function then trigger the desired vehicle function V, in this case unlocking of the hatches of the vehicle V if a valid press has been detected.

The method for activating a vehicle function, illustrated in FIG. 7, will now be described.

In a prior step E0, an ultra-wideband communication is set up between the piece of access equipment SD and the activation device D. UWB waves are transmitted by the activation device D, and simultaneously waves reflected by any part of the body of the user U bearing the piece of access equipment SD, in particular her or his finger when the latter is approached toward, touches or presses on the contact surface S, are received by said device D.

In the following step E1, the reflected waves thus received are processed using the channel impulse response (CIR), which allows the amplitude A and phase φ of each received wave to be determined.

Next, in the second step E2, during a predetermined length of time ΔT at least equal to 4 seconds, the phase I and the phase quadrature Q are determined for each received reflected-wave signal.

In the third step E3, the phase variation Δφ of the reflected waves is compared, during the predetermined length of time ΔT, with a predetermined phase-value profile. The predetermined profile has a phase rotation comprised between −270° and −180°.

If the values of the phases stored during said length of time exhibit a phase rotation comprised between −270° and −180°, then the method passes to the following step E4, otherwise the method returns to the step of analyzing the received waves and carries out a new CIR analysis of new received reflected waves.

If the phase of the received waves has undergone a rotation of its values then, in the fourth step E4, a comparison is made between the values of the amplitude A of the received reflected-wave signals, and a predetermined amplitude-value profile.

If the amplitude values stored during the predetermined length of time ΔT exhibit an increase ΔA greater than a threshold value ΔAs, then a press of the user U has been detected and the vehicle function may be triggered (Step E5).

Otherwise, if the amplitude values stored during the predetermined length of time ΔT do not exhibit an increase or if this increase is less than the threshold value ΔAs, then no press has been detected and the vehicle function is not triggered.

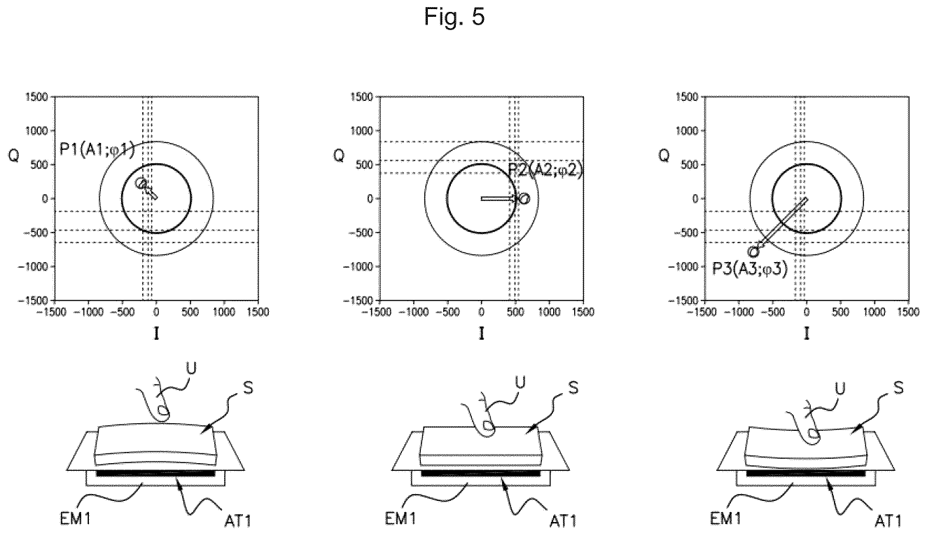

This is illustrated in FIG. 5. FIG. 5 shows, for three cases, the variation in phase and amplitude of the waves received during the predetermined length of time ΔT, the three cases being an approach, a touch and then a valid press of the user U on the contact surface S, under which is located the UWB communication antenna AT1.

To the left of FIG. 5, the user's finger is at a distance P1 from the contact surface. At this distance P1, the waves received have an amplitude A1 and a phase φ1.

In the middle of FIG. 5, the user's finger is touching the contact surface S: at this new distance P2, the waves received have an amplitude A2 greater than A1 and a phase φ2, shifted by −135° with respect to φ1.

To the right of FIG. 5, the user's finger is pressing on the contact surface S: at this new distance P3, the waves received have an amplitude A3 greater than A1, the variation in amplitude between A3 and A1 being greater than the threshold value ΔAs, and have a phase q3, shifted by −135° with respect to q2 and therefore by −270° with respect to φ1.

Since the variation in amplitude between A1 and A3 is greater than the threshold ΔAs and the variation in phase between φ1 and φ3 is indeed comprised between −270° and −180°, the press of the user U on the contact surface S is validated and the vehicle function is triggered.

This very particular spiral-shaped signature from P1 to P3 is characteristic of an approach then a valid press of the user U on the contact surface S.

The method for activating a vehicle function according to an aspect of the invention is particularly ingenious insofar as an ultra-wideband communication antenna usually used to communicate with the piece of “hands-free” access equipment is used here to detect a human contact on a contact surface.

The UWB antenna thus has two functionalities, its primary UWB-communication function and an additional press-detection function, this making it possible to dispense with an inductive sensor.

The synergy of the two functionalities in a single UWB antenna makes it possible to reduce costs, but also the space allocated to the activation device D.

1. A method for activating a vehicle function, by an activation device, from a piece of “hands-free” access equipment borne by a user, activation of the function being triggered by detection of a press of the user on a contact surface(S) of the vehicle, and depending on a result of authentication of the piece of equipment, the activation device comprising at least one transceiver that is located under the contact surface and that is able to communicate with said piece of equipment via ultra-wideband, the method comprising:
a) ultra-wideband transmission to said piece of equipment,
b) reception of reflected waves,
c) comparison, during a predetermined length of time,
i) of values of the phase of the reflected waves with a predetermined phase-value profile, said profile exhibiting a phase rotation, and
ii) of values of the amplitude the reflected waves with a predetermined amplitude-value profile, said profile exhibiting an increase in amplitude, representing a spiral-shaped signature,
d) detection of a press of the user on the contact surface depending on the result of said comparisons, and
e) activation of the vehicle function if the press has been detected.

2. The activation method as claimed in claim 1, wherein a phase rotation corresponds to a variation of the phase values comprised between −180° and −270° during the predetermined length of time.

3. The activation method as claimed in claim 1, wherein an increase in amplitude corresponds to a variation in amplitude values above a threshold during the predetermined length of time.

4. A device for activating a vehicle function, said device being configured to be installed in a motor vehicle, activation of the function being triggered by detection of a press of the user on a contact surface of the vehicle, and depending on a result of authentication of the piece of equipment, the activation device comprising at least one transceiver that is located under the contact surface and that is able to communicate with said piece of equipment via ultra-wideband, the device comprising:
a) means for receiving reflected ultra-wideband waves
b) means for comparing, during a predetermined length of time, values of the
phase of the reflected waves with a predetermined phase profile, said profile exhibiting a phase rotation,
c) means for comparing, during the predetermined length of time, values of the amplitude of the reflected waves with a predetermined amplitude-value profile, said profile exhibiting an increase in amplitude,
d) means for detecting a press of the user on the contact surface depending on the results of said comparison, and
e) means for activating the vehicle function if the press has been detected.

5. The activation device as claimed in claim 4, wherein the means for comparing values of the phase of the reflected waves compare said values with a phase rotation comprised between −180° and −270° during the predetermined length of time.

6. The activation device as claimed in claim 4, wherein the means for comparing values of the amplitude compare said values with an increase in amplitude above a threshold during the predetermined length of time.

7. A non-transitory computer program product comprising program code instructions for executing the steps of the method as claimed in claim 1 when said program is executed on a computer.

8. A motor vehicle, comprising an activation device as claimed in claim 4.

9. The activation method as claimed in claim 2, wherein an increase in amplitude corresponds to a variation in amplitude values above a threshold during the predetermined length of time.

10. The activation device as claimed in claim 5, wherein the means for comparing values of the amplitude compare said values with an increase in amplitude above a threshold during the predetermined length of time.
